(19) United States
(12) Patent Application Publication
(10) Pub. No.: US 2005/0213313 A1
(43) Pub. Date: Sep. 29, 2005

(54) Modular electroluminescent flexible light source

(76) Inventors: Israel Baumberg, Maaleh Adumim (IL); Oleg Berezin, Maaleh Adumim (IL); Guy Daniely, Jerusalem (IL); Joseph Dvir, Mevaseret Zion (IL); Boris Gorelik, Zur-Hadassa (IL); Netta Kerem, Beit Aryeh (IL); Moshe Voskoboinik, Maaleh Adumim (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/990,461

(22) Filed: Nov. 18, 2004

(30) Foreign Application Priority Data
Nov. 19, 2003 (IL) IL 158952

(51) Int. Cl. F21K 2/00

(52) U.S. Cl. 362/34

(57) ABSTRACT

An electroluminescent lighting filament having a connector at a end thereof that may be removably connected to a connector at an end of a second electroluminescent lighting filament so that such electroluminescent lighting filament may be connected to another electroluminescent lighting filament. A storage spool upon which such electroluminescent lighting filament may be stored and unwound.

### CROSS-REFERENCE TO RELATED APPLICATIONS

The present application takes priority from Israeli Patent Application Number 158952, filed with the Israeli Patent Office on Nov. 19, 2003.

### FIELD OF THE INVENTION

The present invention relates generally to lighting systems, and more particularly, to a modular electroluminescent lighting system.

### BACKGROUND OF THE INVENTION

In cases of industrial or road accidents, consequences of terrorist acts, natural hazards or other situations, there may be a need for flexible extended light sources in an area. Such light sources can be used in the darkness or faint lighting for example, among other things, for contouring dangerous zones or marking-out evacuation routes.

Known systems of emergency lighting involve similar light sources using lightguide fibers, for example, as disclosed in U.S. Pat. No. 5,982,969 (Sigiyarna et al.), and U.S. Pat. No. 6,450,677 (Knauer et al.). If the light source is several dozen meters long, however, such systems may require high-power and heavy equipment, which limits their portability.

Electroluminescent wires represent suitable light sources for systems described in U.S. Pat. No. 5,485,355 (Voskoboinik et al.), U.S. Pat. No. 5,869,930 (Baumberg et al.) and U.S. Pat. No. 6,400,093 (Baumberg et al.)

Many electroluminescent wires include two coaxial electrodes, namely an internal one representing a wire and an external one being transparent, with dielectric and electroluminescent layers arranged between them. At the application of alternating voltage of suitable frequency and amplitude to the electrodes, the electroluminescent layer emits light that comes out through the transparent electrode and external insulating polymer layers. Since the external transparent electrode has a high sheet resistance, a wire contact to the transparent electrode is inserted along the entire length of the electroluminescent wire in order to level the voltage along the light source. The resistance of electrodes and their contacts may restrict the maximal current through the electroluminescent wire, which, in turn, may impose a restriction on the length of the electroluminescent wires. Therefore, the known emergency lighting systems based on electroluminescent wires have a limited light source length.

### SUMMARY OF THE INVENTION

According to embodiments of the invention, a method of connecting electroluminescent filaments is disclosed, comprising connecting a first connector at an end of a first electroluminescent filament to a second connector at an end of a second electroluminescent filament.

According to embodiments of the invention, an electroluminescent lighting system is disclosed comprising an electroluminescent lighting filament, a power source, a first connector attached to an end of the electroluminescent lighting filament, and a second connector attached to an end of an other electroluminescent lighting filament, wherein the power source is to supply power to the electroluminescent lighting filament and the first connector is to connect to the second connector to join the electroluminescent lighting filament with the other electroluminescent lighting filament.

According to embodiments of the present invention, an electroluminescent lighting device is disclosed comprising an electroluminescent filament, a first connector at a first end of the device, and a second connector at a second end of the device, wherein the first connector is to connect to a connector on a second electroluminescent device, and the second connector is to connect to a connector on a third electroluminescent device.

It will be understood that the invention is not limited by the above, and the further embodiments and variations on the present invention are provided below.

### BRIEF DESCRIPTION OF THE DRAWINGS

Embodiments of the invention will be understood and appreciated more fully from the following detailed description taken in conjunction with the drawings in which:

FIG. 1 shows the general view of one module of electroluminescent flexible modular light source with connectors for joining modules, in accordance with an embodiment of the present invention;

FIG. 2 shows a section of electroluminescent flexible modular light source consisting of two modules, in accordance with an embodiment of the present invention;

FIG. 3 shows an electroluminescent flexible modular light source consisting of two modules, in accordance with an embodiment of the present invention;

FIG. 4 shows a schematic diagram of an electroluminescent filament connection with a power supply unit, in accordance with an embodiment of the present invention;

FIG. 5 shows a cross-section of an electroluminescent filament with an additional insulated wire, in accordance with an embodiment of the present invention;

FIG. 6 shows a schematic diagram of a power supply unit connection to an electroluminescent filament with an additional insulated wire connected with one of the electrodes of the electroluminescent filament, in accordance with an embodiment of the present invention;

FIG. 7 shows a frame with two modules of electroluminescent flexible modular light source, wound on a spool, in accordance with an embodiment of the present invention;

FIG. 8 shows a view of a housing for storage and transportation of an electroluminescent flexible modular light source, in accordance with an embodiment of the present invention;

FIG. 9 shows a module comprising three braided electroluminescent filaments, in accordance with an embodiment of the present invention; and

FIG. 10 shows a version of a connector, in accordance with an embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention. The scope of the invention is not limited to the examples given.

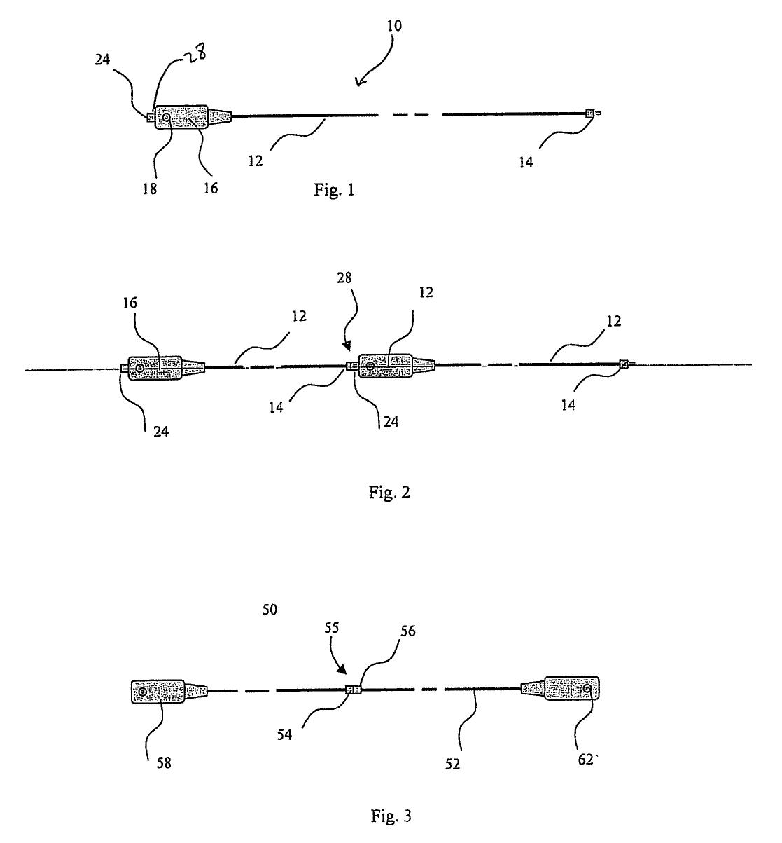

Reference is made to FIG. 1, a module of an electroluminescent flexible light source in accordance with an embodiment of the invention. Module 10 may include for example a power supply unit 16 that may be operably connected to an electroluminescent filament 12. Power supply unit 16 may include a switch 18 through which voltage may be supplied to filament 12 and a part 24 of mechanical connector 28. The free end of electroluminescent filament 12 may include another part 14 of connector 28. In one embodiment, power supply unit 16 of module 10 may contain 12 AA batteries, and may support the luminescence of electroluminescent filament 12 that is 30 meters long for 6 hours. Other power sources may be used with other support characteristics. The power supply unit 16 may be shaped as a hollow cylinder 260 mm long and 60 mm in. Other configurations, shapes and sizes may be used.

Reference is made to FIG. 2, a depiction of a section of electroluminescent flexible modular light source including two modules, in accordance with an embodiment of the present invention. Part 14 of connector 28 located for example on the end of electroluminescent filament 12 of one module 10 is connected with part 24 of connector 28 located on power supply unit 16 of a second module 10. A large number of such modules 10 may be linked together to contour or mark out a route of considerable length using luminescent filament 12.

In some embodiments, a module 10 of electroluminescent filament 12 for example thirty meters long made on the basis of a standard EL wire O₂S LYTEC® may weigh 400 grams. Thus, the weight of one module 10 with its power supply may be 1.3 kg. A module 10 may be arranged in a container where electroluminescent filament 12 may be coiled. When using a module 10, an operator may take the required number of modules 10 to the area requiring lighting, lay electroluminescent filament 12 of the first module along the route, switch on switch 18 of power supply unit 16, mechanically connect the free end of electroluminescent filament 12 of the second module's 10 power supply unit 16 to the end of the first filament 12 and so on, creating a continuous luminescent line that may be located on the ground in the air or in other medium. In some embodiments, the luminescent line may be formed into a loop by connecting the free end of electroluminescent filament 12 of the last module 10 with power supply unit 16 of the first module 10.

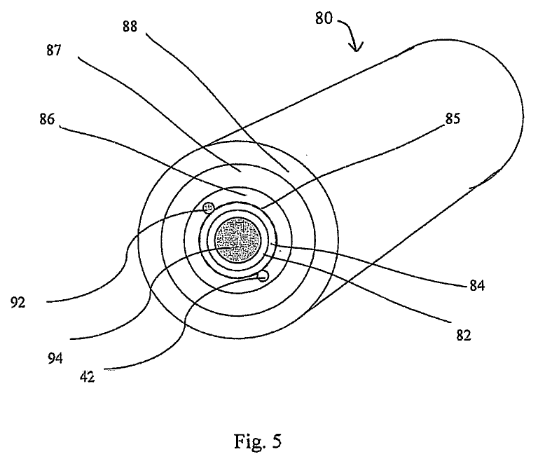

FIG. 3 shows an embodiment of electroluminescent flexible module consisting of two modules. Module 50 may comprise electroluminescent filament 52 with one end connected to driver 58, and another end connected with electroluminescent filament 52 to a driver 62 of the second module. The ends of electroluminescent filament 52 may be connected by means of the respective parts 54 and 56 of mechanical connector 55.

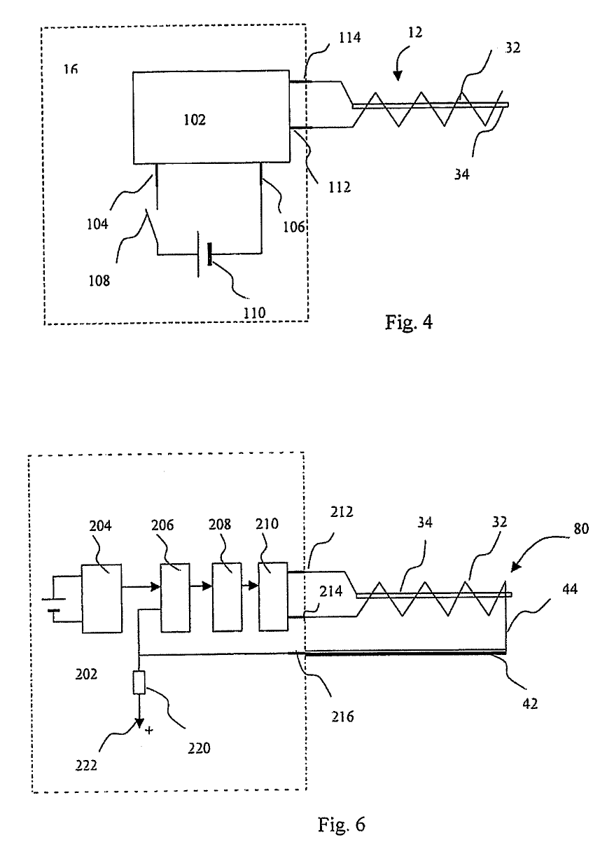

FIG. 4 shows a schematic diagram of electroluminescent filament 12 in connection with power supply unit 16, in accordance with an embodiment of the invention. Battery 110, which may be located for example inside the power supply unit 16, may be connected through switch 108 with input terminals 104 and 106 of DC-to-AC inverter 102. Output terminals 112 and 114 of inverter 102 may be connected with internal wire electrode 34 and wire contact 32 leading to an external transparent electrode (not shown in FIG. 4). In some embodiments, between the internal and external electrodes there may be a layer of electroluminescent powder in a polymer binder. Upon the application of AC voltage of appropriate frequency and amplitude, electroluminescent filament 12 may emit light.

FIG. 5 shows the cross-section of such electroluminescent filament 80, in accordance with an embodiment of the invention. In some embodiments, electroluminescent flexible modular light source may be used in conditions of threat of explosion/fire threat or elevated mechanical loads. Central internal electrode 94, which may be made of for example nickel-clad copper wire with a thickness of for example 0.7 mm in diameter, may be coated with dielectric reflecting layer 82, which may be for example 40 μm thick to 60-μm-thick. Other thicknesses may be used. Electroluminescent layer 84 may be applied to dielectric layer 82. Electroluminescent layer 84 may be coated with transparent conducting ITO layer 85, which constitutes the external transparent electrode. ITO layer 85 may be for example 400-500 Å thick, and its resistance may be 500-600 Ohm. Other thicknesses may be used. To level the voltage drop along the transparent electrode, wire contact 32 made of silver-plated copper wire 0.2 mm in diameter may be laid along the electroluminescent filament. Additional electrically insulated wire 42 made of copper wire 0.2 mm in diameter coated with several varnish layers may be laid in parallel with wire contact 32. The entire system may be successively coated with three polymer layers:
PVDF-based copolymer layer 86, 350-450 μm thick;
PVC layer 87, 600-800 μm thick;
PVDF-based copolymer layer 88, 700-900 μm thick.

The electroluminescent filament diameter amounts to approximately 4.0-5.0 mm. Other dimensions may be used. The above described construction of the electroluminescent filament has two basic differences from the construction of a standard EL Wire 02S series:
additional electrically insulated wire 42;
additional external PVDF layer 88.

Additional PVDF layer 88 may considerably increase the mechanical strength of electroluminescent filament 80 in comparison with the standard design (breaking strength of electroluminescent filament 80 is 25 kg; it can stand the pressure of 70 kg/cm²). Additionally, PVDF is chemically inert and nonflammable.

FIG. 6 shows a schematic diagram of the connection of special driver 202 with electroluminescent filament 80, in accordance with an embodiment of the invention. In some embodiments, driver 202 may include source of DC voltage 204 comprising for example electrical batteries or accumulators; two-input logical circuit 206; generator of sinusoidal impulses 208; and output amplifier 210.

In some embodiments, logical circuit 206 may operate as follows: DC voltage fed to one of its inputs appears at the circuit output only if logical “0” is fed to the second driving input. If, however, “+” is fed to the driving input of logical circuit 206, “0” appears at its output.

In a normal operation mode, wire contact 32 may be connected with output 214 of driver 202, which is permanently fed with “0”. Additional insulated wire 42 at the free end of electroluminescent filament 80 is electrically connected with wire contact 32 by connector 44. The second end of insulated wire 42 is connected through driver input 216 with the driving input of logical circuit 206. When “0” is fed to the driving input of logical circuit 206, DC voltage is fed from DC voltage source 204 through logical circuit 206 to generator of sinusoidal impulses 208, The sinusoidal signal generated by generator 208 is fed through driver output 212 to central electrode 34, which causes the luminescence of electroluminescent filament 80. In this case, a small current flows in the circuit of resistor 220. If electroluminescent filament 80 is ruptured or cut in the course of work, insulated wire 42 will be also broken. It means that “+” will be fed to the driving input of logical circuit 206 through resistor 220. In this case, DC voltage is not fed to the input of generator 208, the generator will cease generating, and “0” will appear on all the electrodes of electroluminescent filament 80. This circumstance is especially important when electroluminescent filament 80 operates under the conditions of explosion and fire threat, because it secures against wire sparking even at the moment of its rupture due to any reason.

Modules of electroluminescent flexible modular light source may be stored on spools. The modules may be delivered wound on spools to the place of their usage and connected there. In the process of work, the electroluminescent filament may be unwound from the spools and rewound after completing the work.

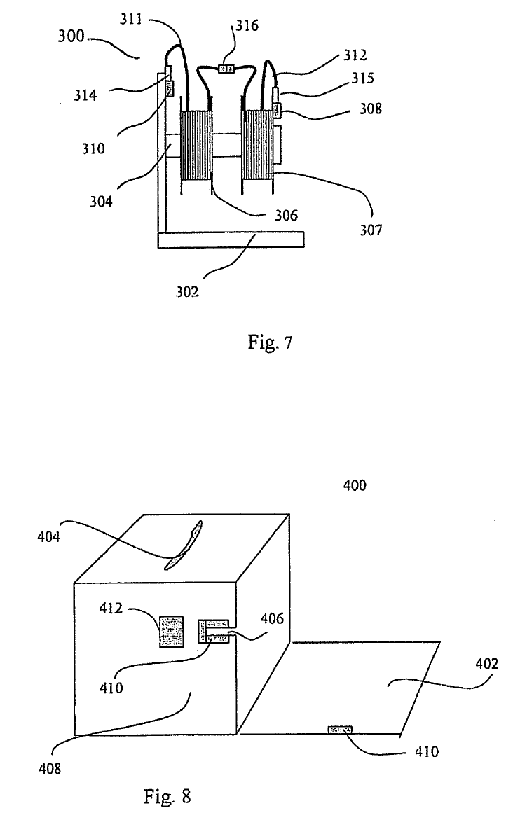

FIG. 7 shows an embodiment of electroluminescent flexible modular light source 300 consisting of two modules using spools, in accordance with an embodiment of the invention. In the idle state, electroluminescent filament 311 of the first module may be wound on spool 306, whereas electroluminescent filament 312 of the second module may be wound on spool 307. Spools 306 and 307 may freely rotate on the axle 304 fixed on the frame 302. Driver 314 of the first module may be fixed in the clamp 310 located on frame 302, whereas driver 315 of the second module is fixed in the clamp 308, on the external side of the jaw of spool 307. The free ends of electroluminescent filaments 311 and 312 are connected by connector 316. Each electroluminescent filament may be for example 50 meters long, and the entire electroluminescent flexible modular light source may be for example 100 meters long. The weight of the entire system may be approximately 12 kg, and the weight of a coiled module that can be used independently may be approximately 4 kg.

In operation, the frame with the ready-for-operation system is delivered to the needed place. The operator takes the driver 314 out of clamp 310 and pulls out electroluminescent filament 311 holding driver 314 in hand. After 50 m, electroluminescent filament 311 is completely unwound from spool 306, and after that electroluminescent filament 312 connected with electroluminescent filament 311 by connector 316 may start unwinding. When the entire electroluminescent filament 312 unwinds from spool 307, driver 315 comes out of clamp 308. The operator can either proceed with the displacement of 100-meter-long luminescent cord or leave the cord on the site.

For better storage and easy transportation, the entire electroluminescent flexible modular light source can be placed into a special housing. FIG. 8 shows a design of housing for the electroluminescent flexible modular light source, in accordance with an embodiment of the invention. Housing 400 represents a case with a dropping side wall 402 and a handle 404. In the front wall 408 there is a rectangular hole 406 that is open on one side and circled by three freely rotating rollers 410 on the other sides. A similar roller 410 is fixed in the respective place of side wall 402. On the front wall 408 there is also a holder 412 for fastening the driver. A frame as presented in FIG. 7 with coiled modules on it may be inserted into housing 400. A small portion of electroluminescent filament of the first module with the attached driver is brought out through slit 406, and the driver is inserted into holder 412. Side wall 402 may be adjusted vertically, so that the housing 400 gets closed, and the slit 406 becomes a hole circled by rollers 410 on all the sides. An operator may switch on the drivers of both modules, take the driver of the first module out of the holder 412 and start moving. The electroluminescent filament starts unwinding from the spools and coming out through the hole 406.

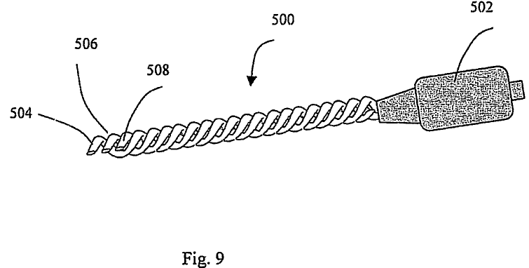

FIG. 9 shows a module of the electroluminescent flexible modular light source with three electroluminescent filaments 504, 506 and 508 twisted in the form of braid 500 connected to power supply unit 502. Other multiple filaments of various colors may be used, and other ways of joining such filaments into a single unit are possible. The free ends of the electroluminescent filaments are not shown in the figure. Electroluminescent filament 504 emits red light, electroluminescent filament 506—green light, and electroluminescent filament 508—blue light. Other colors may be used. In addition to the elements shown in FIG. 6, power supply unit 502 comprises a sequencer allowing the connection of electroluminescent filaments to the driver with a specified on-off time ratio, so that each electroluminescent filament receives packets of sinusoidal pulses of certain duration from the driver. Such connection makes it possible to realize various optical effects in braid 500. At the pulse packets duration of 0.2-0.3 sec, a human eye may observe an oriented wave of changing color along braid 500. This effect may make it possible to specify the direction of motion for people who have lost their bearings in the state of stress or under the conditions of limited visibility. If the duration of pulse packets is below 0.04 sec, eyes do not distinguish the flashes of separate electroluminescent filaments, and it becomes possible to control the color of luminescence of the entire braid 500 as a single RGB pixel.

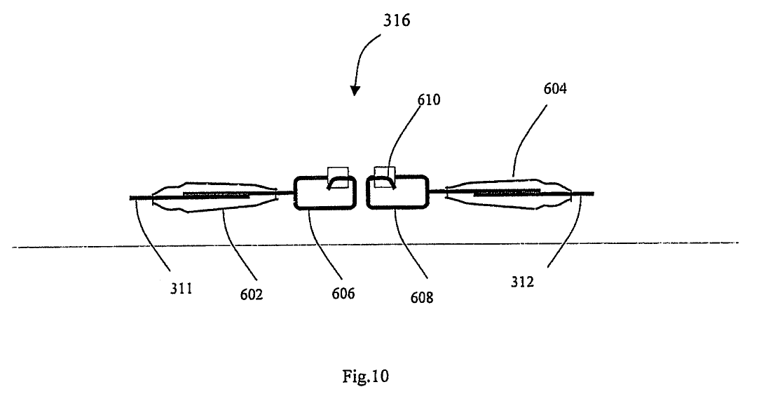

FIG. 10 shows a version of a connector, in accordance with an embodiment of the invention. Electroluminescent filament 311 may be mounted by for example shrink tube 602 to steel ring 606 provided by spring-loaded lock 610. Electroluminescent filament 312 may be mounted by shrink tube 604 to steel ring 608 provided by spring-loaded lock 610. Rings 606 and 608 may be inserted one into another to form mechanical connection 316. The connection of two rings 606 and 608 can be held, disconnected or removed as well. Other connectors may be used, such as for example a hook and eye with a fastener, straps with a clip or for example VELCRO, a bolt and bracket or other suitable connectors.

It will be appreciated by persons skilled in the art that embodiments of the invention are not limited by what has been particularly shown and described hereinabove. Rather the scope of at least one embodiment of the invention is defined by the claims below.

1. An electroluminescent lighting device comprising an electroluminescent filament and at least one connector at an end thereof to operably connect said electroluminescent device to another electroluminescent device.

2. An electroluminescent lighting device comprising:
an electroluminescent filament;
a first connector at a first end of said filament to connect said electroluminescent device to a connector on a second electroluminescent device; and
a second connector at a second end of said filament to connect said electroluminescent device to a connector on a third electroluminescent device.

3. The device as in claim 2, said first connector comprising a spring loaded lock.

4. The device as in claim 2, wherein said first connector is attached to a power source.

5. The device as in claim 2, comprising a storage spool around which to wind said electroluminescent device.

6. The device as in claim 5, comprising a second storage spool around which to wind said second electroluminescent device.

7. The device as in claim 6, comprising a housing to hold said spool and said second spool.

8. A method of connecting electroluminescent filaments comprising connecting a first connector at an end of a first electroluminescent filament to a second connector at an end of a second electroluminescent filament.

9. The method as in claim 8, comprising inserting a spring lock of said first connector into a loop of said second connector.

10. The method as in claim 8, comprising unwinding said first electroluminescent filament from a first storage spool and unwinding said second electroluminescent filament from a second storage spool.

11. The method as in claim 10, comprising storing said first storage spool and said second storage spool in a housing.

12. An electroluminescent lighting system comprising:
first and second electroluminescent lighting filaments;
a power source to supply power to said electroluminescent lighting filaments;
a first connector attached to an end of said first electroluminescent lighting filament; and
a second connector attached to an end of said second electroluminescent lighting filament, said second connector capable of being operably connected to said first connector.

13. The system as in claim 12, comprising a second power source attached to said second electroluminescent lighting filament.

14. The system as in claim 12, comprising a first spool to wind said first electroluminescent lighting filament thereupon, and a second spool to wind said second electroluminescent lighting filament thereupon.

15. The system as in claim 14, comprising a housing to store said first spool and said second spool.

16. A method comprising illuminating an oriented wave along a connected plurality of electroluminescent lighting filaments to create a directional indicator of luminescence along said electroluminescent lighting filaments.

17. The method as in claim 16, comprising delivering packets of sinusoidal pulses with a specified duty cycle.

18. The method as in claim 16, wherein said plurality of electroluminescent lighting filaments includes filaments having a plurality of colors.
